(19) United States
(12) Patent Application Publication
(10) Pub. No.: US 2022/0143698 A1
(43) Pub. Date: May 12, 2022

(54) 'HIGH-ENTROPY LATTICE' ACHIEVED BY 3D PRINTING

(71) Applicant: City University of Hong Kong, Hong Kong (HK)

(72) Inventors: Yang LU, Hong Kong (HK); Wenzhao ZHOU, Hong Kong (HK); Rong FAN, Hong Kong (HK)

(21) Appl. No.: 17/436,598

(22) PCT Filed: Apr. 10, 2020
(86) PCT No.: PCT/CN2020/084116

§ 371 Date: Sep. 5, 2021

Related U.S. Application Data
(60) Provisional application No. 62/835,826, filed on Apr. 18, 2019.

(51) Int. Cl. B22F 10/00; B33Y 80/00; C22C 1/04; B33Y 10/00

(52) U.S. Cl. CPC B22F 10/00; B33Y 80/00; C22C 2200/04; B33Y 10/00; C22C 1/04

(57) ABSTRACT

A new lattice structure design or discrimination method inspired by the crystalline structure of high-entropy alloy is described. A method for providing a high-entropy lattice (HEL) having a pseudo-random lattice structure comprises fabricating a locally distorted lattice structure and generating a high-entropy lattice (HEL) having a macroscopically ordered configuration from the locally distorted lattice structure. An article of manufacture comprising a high-entropy lattice (HEL) having a pseudo-random lattice structure, wherein the pseudo-random lattice structure is a macroscopically ordered lattice structure that includes locally distorted lattice structures, may be provided.

### TECHNICAL FIELD

### Background of the Invention

Because of its unique crystalline structure, high-entropy alloys (HEAs) have attracted great research interest, since first reported in 2004, for their superior and tunable mechanical and physical properties, such as high strength and ductility, damage tolerance, and high corrosion resistance. Its excellent properties are attributed to the macroscopic single crystalline structure with atomic scale distorted lattice structure introduced by mixing five or more different atoms of different atomic radius with equal or near equal composition in a concentrated solution. The distorted lattices will raise the energy barrier against dislocation movement and thus lead to the HEAs' outstanding mechanical properties.

Along with the rapid developments of high resolution 3D printing technology, a number of lattice metamaterials with lightweight and great mechanical properties are fabricated by researchers. And there're more and more reports related to the lattice structure design and optimization based on the 3D printing technique and taking the mechanical test results of these lattice architectures into consideration.

### BRIEF SUMMARY OF THE INVENTION

The present invention is directed to systems and methods which provide a strategy to design and fabricate a range of disordered and locally distorted single crystalline lattice structures (simple cubic, FCC, BCC) inspired by HEA crystal lattice. The structures may be tuned with desired mechanical behavior with optimization algorithms, to achieve desirable mechanical and functional properties, such as ultralight but high strength and high damage-tolerance. The novel ‘high-entropy lattice’ (HEL) structures can be used for many structural engineering and industrial applications.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which.

FIG. 1(a) shows the crystalline structure of an exemplary HEA (high-entropy alloy);

FIG. 1(b) shows an exemplary lattice structure with an order arrangement; and

FIG. 1(c) shows a high-entropy lattice structure according to embodiments of the invention.

### DETAILED DESCRIPTION OF THE INVENTION

Embodiments of the invention produce a new lattice structure design or discrimination method inspired by the crystalline structure of high-entropy alloy. In principle, lattice distortion can interact with dislocations, and significant strengthened HEAs can be obtained. Embodiments of the designed structure have great elastic property and damage tolerance, which are similar to the influence of lattice distortion on the mechanical properties of HEAs. Using a high precision manufacturing method, a similar distorted lattice structure of HEAs can be observed at the macro scale according to embodiments. The structure of embodiments can be produced in a higher-efficient, easier, and lower-cost way. Lightweight lattice materials with these mechanical properties satisfy the needs of industrial applications such as aerospace, automotive, mechanical, and construction.

As compared to the ordered cellular or crystal-like structure, introducing distortion can raise the confusion of the structure, although the mechanical performance is much higher than the ordered cellular or crystal structure. Because for a single lattice structure, cracks are easily generated under loading, propagating rapidly throughout the whole structure and causing fractures. For the HEAs lattice, cracks/shear band would be stopped by the distorted unit cell. Along with the strengthening of the material, the energy absorption can also be improved. Further, as compared to the existing ordered cellular optimization method, the topological structure optimization method, and the bio-inspired structure design method, the design strategy of embodiments can save computational cost of optimization and inherit the mechanical properties of HEAs. Also, as compared to the existing manufacturing method, the stereolithographic additive manufacturing method with high precision and large breadth of embodiments can produce the 3D designed structure more accurately and easier.

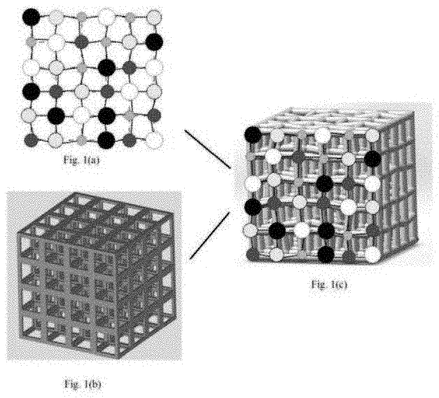

A high-entropy lattice structure inspired by HEA is designed according to embodiments of the present invention. Such high-entropy lattice structures of embodiments have unique properties, such as ultra-low density, high-strength, negative Poisson's ratio, high resilience, and energy absorption, and are well suited for applications in fields such as building or reinforcement materials in construction, functional materials for electronic devices or energy storage, and bio-scaffolds for cell culturing in biomedicine. A schematic of high-entropy lattice structure in accordance with concepts of the present invention is shown in FIGS. 1(a)-1(c).

FIG. 1(a) shows the crystalline structure of an exemplary HEA (high-entropy alloy). Unlike the regular ordered tetragonal structure, its local structure is not regular but rather disordered.

FIG. 1(b) shows an exemplary lattice structure, as may be utilized according to embodiments of the invention, with an order arrangement. This structure may, for example, be printed by using high resolution 3D printing machine. The cross section of each beam can be set as rectangular or circular shape. The size of the cross section of each beam can also be changed for desirable mechanical properties. The behavior of the lattice can be modified through a careful design of the lattice unit cells and material selection, giving access to unprecedented properties, such as ultralight with high strength and negative passion ration.

It should be appreciated, however, that an ordered structure with a single orientation will become highly localized on specific planes with defined lattice directions. Accordingly, a fracture is easy to propagate along the specific planes.

FIG. 1(c) shows an exemplary high-entropy lattice structure provided in accordance with concepts of the present invention. Unlike a lattice with regular ordered arrangement (e.g., the lattice structure of FIG. 1(b)), each unit cell for this structure are slightly different and arranged randomly or pseudo randomly. This structure prevents the rapid propagation of slip during deformation. The unit cell also can be set as simple cube, face-centered cubic (FCC), body-centered cubic (BCC), a hexagonal close-packed (HCP), a diamond cubic crystal, or other structure.

High-entropy lattice structures in accordance with embodiments of the invention, wherein each unit cell is slightly different and arranged randomly or pseudo randomly (e.g., the structure of FIG. 1(c)), may be designed and optimized with CAD software such as Solidworks. Different scale HEAs lattice structures have been fabricated by the present inventors in a laboratory setting from such designs using high resolution 3D-printing machines. Moreover, in situ mechanical test, DIC and FEM analysis have been used by the present inventors to study the deformation behaviors of the 3D-printing material. The parameters of the distorted lattice of embodiments of the present invention may be optimized based upon the experiment results.

As may be appreciated from the foregoing, a unit cell of a high-entropy lattice structure of embodiments of the present invention may be set as simple cube, face-centered cubic (FDD), body-centered cubic (BCC), hexagonal close-packed (HCP), diamond cubic crystal, or other shapes depending on the required mechanical and functional properties. A simple lattice structure comprising the unit cell with an ordered arrangement may be designed. In this lattice, the length, angle, and cross section of each beam of unit cell can be altered in a small range randomly or pseudo randomly to provide a high-entropy lattice structure according to embodiments of the invention. The resulting high-entropy lattice structure, having the features of macroscopic ordered with local distributed distortion and variation, may be designed and verified by CAD and CAE software, respectively. Standard optimization procedures for this structure may be used to achieve optimal properties. The optimized high-entropy lattice structure may be assembled to obtain a macroscale structure with ideal structural and functional properties.

In accordance with embodiments a method for providing a high-entropy lattice (HEL) having a pseudo-random lattice structure comprises fabricating a locally distorted lattice structure and generating a high-entropy lattice (HEL) having a macroscopically ordered configuration from the locally distorted lattice structure. The macroscopically ordered lattice structure may comprise a macroscopic crystal lattice structure configuration, such as a simple cubic configuration, a face-centered cubic (FCC) configuration, a body-centered cubic (BCC) configuration, a hexagonal close-packed (HCP) configuration, or a diamond cubic crystal structure. Fabricating the locally distorted lattice structure may comprise forming a plurality of beams, wherein beams of the plurality of beams have a differing feature selected to provide local distortion of the lattice structure, and fabricating a plurality of unit cells from the plurality of beams. Forming the plurality of beams may comprise three-dimensional (3D) printing the plurality of beams using a high resolution 3D printer. The differing feature may, for example, include differing lengths, differing angles, and/or differing cross sections. The differing feature of beams of the plurality of beams of the unit cell may be selected to differ pseudo-randomly and/or for desirable mechanical properties of the HEL.

As can be appreciated from the forgoing, an article of manufacture comprising a high-entropy lattice (HEL) having a pseudo-random lattice structure, wherein the pseudo-random lattice structure is a macroscopically ordered lattice structure that includes locally distorted lattice structures, may be provided according to embodiments of the present invention. The macroscopically ordered lattice structure may comprise a macroscopic crystal lattice structure configuration. The macroscopic crystal lattice structure configuration may, for example, comprise a simple cubic configuration, a face-centered cubic (FCC) configuration, a body-centered cubic (BCC) configuration, a hexagonal close-packed (HCP) configuration, or a diamond cubic crystal structure. The locally distorted lattice structures may comprise a plurality of unit cells each formed from a plurality of beams, wherein the plurality of beams forming a unit cell of the plurality of cells comprise beams having a differing feature selected to provide local distortion of the lattice structure. The differing feature may, for example, include differing lengths, differing angles, and/or differing cross sections. The differing feature of each beam of the plurality of beams of the unit cell may differ pseudo-randomly according to embodiments. The differing feature of embodiments may be selected for desirable mechanical properties of the HEL. As an example, the differing feature of some embodiments includes a difference in beam length, wherein the difference in the beam lengths is no more than 5% as compared to its pristine lattice structure without deformation, and wherein the pristine lattice structure is a conventional single crystal lattice structures with uniform lattice parameter. As a further example, the differing feature of some embodiments includes a difference in beam angle, wherein the difference in the beam angel is no more than 5° as compared to its pristine lattice structure without deformation, and wherein the pristine lattice structure is a conventional single crystal lattice structures with uniform lattice parameter. The macroscopically ordered lattice structure that includes locally distorted lattice structures comprises a three-dimensional (3D) printed lattice structure according to embodiments of the invention. The pseudo-random lattice structure may be fabricated to have a nanoscale size, a microscale size, or a macroscale size.

With the superior mechanical properties of high-entropy alloy raised by its unique crystalline structure in consideration, a set of disordered/distorted single crystal lattice structures (simple cubic, FCC, BCC) designed in accordance with the concepts of the present invention achieve high strength and damage tolerance. Combined with a high resolution 3D printing technique, the nano/micro scale lattice structure can be realized at the macro scale, and high precision can be guaranteed at the same time. High-entropy lattice (HEL) structures inspired by high-entropy alloy (HEA) crystal lattices are provided according to embodiments of the present invention, where the HEL lattice structure has the feather of macroscopically ordered (simple cubic, FCC, BCC) associated with local distributed distortion and variation. A HEL structure of embodiments utilizes a feature size, including the length, angle, and/or cross section of each beam, that can be slightly different at different unit cells. The HEL structure of embodiments can be fabricated by using different materials for different mechanical and functional purposes, such as using high resolution 3D printing technology. HEL structures of embodiments have unusual tunable mechanical properties than conventional lattice structures for structural and functional application.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. An article of manufacture comprising:
a high-entropy lattice (HEL) having a pseudo-random lattice structure, wherein the pseudo-random lattice structure is a macroscopically ordered lattice structure that includes locally distorted lattice structures.

2. The article of manufacture of claim 1, wherein the macroscopically ordered lattice structure comprises a macroscopic crystal lattice structure configuration.

3. The article of manufacture of claim 2, wherein the macroscopic crystal lattice structure configuration is selected from the group consisting of:
a simple cubic configuration;
a face-centered cubic (FCC) configuration;
a body-centered cubic (BCC) configuration;
a hexagonal close-packed (HCP) configuration; and
a diamond cubic crystal structure.

4. The article of manufacture of claim 1, wherein the locally distorted lattice structures comprise a plurality of unit cells each formed from a plurality of beams, and wherein the plurality of beams forming a unit cell of the plurality of cells comprise beams having a differing feature selected to provide local distortion of the lattice structure.

5. The article of manufacture of claim 4, wherein the differing feature includes at least one feature selected from the group consisting of:
length;
angle; and
cross section.

6. The article of manufacture of claim 4, wherein the differing feature of each beam of the plurality of beams of the unit cell differ pseudo-randomly.

7. The article of manufacture of claim 4, wherein the differing feature is selected for desirable mechanical properties of the HEL.

8. The article of manufacture of claim 4, wherein the differing feature includes a difference in beam length, wherein the difference in the beam lengths is no more than 5% as compared to its pristine lattice structure without deformation, and wherein the pristine lattice structure is a conventional single crystal lattice structures with uniform lattice parameter.

9. The article of manufacture of claim 4, wherein the differing feature includes a difference in beam angle, wherein the difference in the beam angel is no more than 5° as compared to its pristine lattice structure without deformation, and wherein the pristine lattice structure is a conventional single crystal lattice structures with uniform lattice parameter.

10. The article of manufacture of claim 1, wherein the macroscopically ordered lattice structure that includes locally distorted lattice structures comprises a three-dimensional (3D) printed lattice structure.

11. The article of manufacture of claim 1, wherein the pseudo-random lattice structure is fabricated to have a size selected from the group consisting of:
nanoscale;
microscale; and
macroscale.

12. A method comprising:
fabricating a locally distorted lattice structure; and
generating a high-entropy lattice (HEL) having a macroscopically ordered configuration from the locally distorted lattice structure.

13. The method of claim 12, wherein the macroscopically ordered lattice structure comprises a macroscopic crystal lattice structure configuration.

14. The method of claim 12, wherein the macroscopic crystal lattice structure configuration is selected from the group consisting of:
a simple cubic configuration;
a face-centered cubic (FCC) configuration;
a body-centered cubic (BCC) configuration;
a hexagonal close-packed (HCP) configuration; and
a diamond cubic crystal structure.

15. The method of claim 12, wherein the fabricating the locally distorted lattice structure comprises:
forming a plurality of beams, wherein beams of the plurality of beams have a differing feature selected to provide local distortion of the lattice structure; and
fabricating a plurality of unit cells from the plurality of beams.

16. The method of claim 15, wherein the forming the plurality of beams comprises:
three-dimensional (3D) printing the plurality of beams using a high resolution 3D printer.

17. The method of claim 15, wherein the differing feature includes at least one feature selected from the group consisting of:
length;
angle; and
cross section.

18. The method of claim 15, further comprising:
selecting the differing feature of beams of the plurality of beams of the unit cell to differ pseudo-randomly.

19. The method of claim 15, further comprising:
selecting the differing feature of each beam of the plurality of beams of the unit cell for desirable mechanical properties of the HEL.
